(19) United States
(12) Patent Application Publication
(10) Pub. No.: US 2004/0189014 A1
(43) Pub. Date: Sep. 30, 2004

(54) Latch assembly

(76) Inventor: Peter William Harkins, Maroota NSW (AU)

Correspondence Address: D Douglas Price, Steptoe & Johnson, 1330 Connecticut Avenue N W, Washington, DC, 20036, US

(21) Appl. No.: 10/482,659

(22) PCT Filed: Jul. 3, 2002
(86) PCT No.: PCT/AU02/00876

(30) Foreign Application Priority Data
Jul. 6, 2001 (AU) PR 6209

(51) Int. Cl. E05C 1/12

(52) U.S. Cl. 292/164

(57) ABSTRACT

A latch assembly which is suitable for use with doors, windows and other movable members adapted for movement between one or more positions, the assembly including a latch bolt (12) movable between an extended position and a retracted position and a bolt actuating mechanism (20) operable to cause the movement of the latch bolt, the bolt actuating mechanism including drive means (22) and a control member (30) which operatively interconnects the latch bolt and the drive means, the control member including a latch bolt mounting region which enables the latch bolt to be operatively connected to the control member in selected one of a plurality of mounting positions.

This invention relates generally to latch assemblies which are suitable for use with doors, windows and other movable members adapted to move between one or more positions.

The latch assembly is particularly suitable for use with doors and as a matter of convenience the invention will hereinafter be described with reference to that particular application. It is to be understood however, that this is not to be taken as a limitation as to the scope of the invention.

Some types of doors and in particular doors which are used internally, generally comprise a peripheral frame to which panels are secured on opposite sides thereof. A mounting block is provided between the panels to which a latch assembly can be installed. Generally latch assemblies currently in use comprise a cylindrical housing into which a latch bolt is mounted for movement between retracted and extended positions and a manual drive in the form of a handle for causing retraction of the latch bolt. The provision of the mounting block and subsequent installation of the latch assembly to the mounting block can be time consuming both at the construction of the door stage as well as the latch installation stage. A further problem associated with known latch assemblies is that when the door is being mounted to the door jamb considerable time is taken in ensuring that the latch bolt and keeper mounted to the doorjamb properly align.

It is an object of the present invention to provide a latch bolt assembly which alleviates one or more of the aforementioned problems.

According to one aspect of the present invention there is provided a latch assembly which is suitable for use with doors, windows and other movable members adapted for movement between one or more positions, the assembly including a latch bolt movable between an extended position and a retracted position and a bolt actuating mechanism operable to cause the movement of the latch bolt, the bolt actuating mechanism including drive means and a control member which operatively interconnects the latch bolt and the drive means, the control member including a latch bolt mounting region which enables the latch bolt to be operatively connected to the control member in selected one of a plurality of mounting positions.

In one form, the control member may include an elongated bar with the mounting positions disposed therealong. The mounting region may be in the form of one or more slots therein. The mounting positions may be disposed side by side along the bar or in spaced disposition relative to one another.

The latch bolt may include a bolt head and a connecting rod or bar extending therefrom. The latch bolt may include means for releasably connecting the bolt in a selected one of the mounting positions. To this end the latch bolt may include one or more notches or recesses in the connecting rod which in a first position enables the connecting rod or bar to be inserted into the aperture or slot and then rotate it to a position wherein removable from the mounting position is inhibited. The latch bolt may include a series of groups of notches or recesses spaced from one another, each group being adapted to be selectively connected to the mounting region. The bolt may be constructed from separate pieces or may for example, be a one piece casting.

In another form of the invention the mounting positions may be in the form of a series of apertures in the bar or in the form of one or more slots having sections of the slots defining separate mounting positions. The mounting positions may be disposed side by side along the bar or in spaced disposition relative to one another. The means for releasably connecting the bolt to a selected one of the mounting positions may include one or more locating pins in the latch bolt connecting rod at one end thereof which in a first position enables the bolt end to be inserted into the aperture or slot and then rotate it to a position wherein removal from the mounting zone is inhibited. The latch bolt may include a series of groups of retaining pins in the connecting rod spaced from one another, each group being adapted to be selectively connected to one of the mounting zones.

Spring means may be provided for urging the control member and latch bolt into the extended position.

The drive means may include a housing for a rotatable member which is operatively connected to the latch bolt so that rotation of the rotatable member causes the control bar to move so as to cause the latch bolt to move between the latching and release positions. A handle may be operatively connected to the rotatable member, the handle being manually operable. Preferably, the housing is rigidly fixed to the door. By this arrangement the housing provides for a strong support for the handle via the rotatable member.

The assembly may further include guide means for assisting in guiding the movement of the control member. The guide means and rotatable member may be mounted or form part of a unitary latch assembly housing.

Preferred embodiments of the invention will be hereinbefore described with reference to the accompanying drawings, and in those drawings:

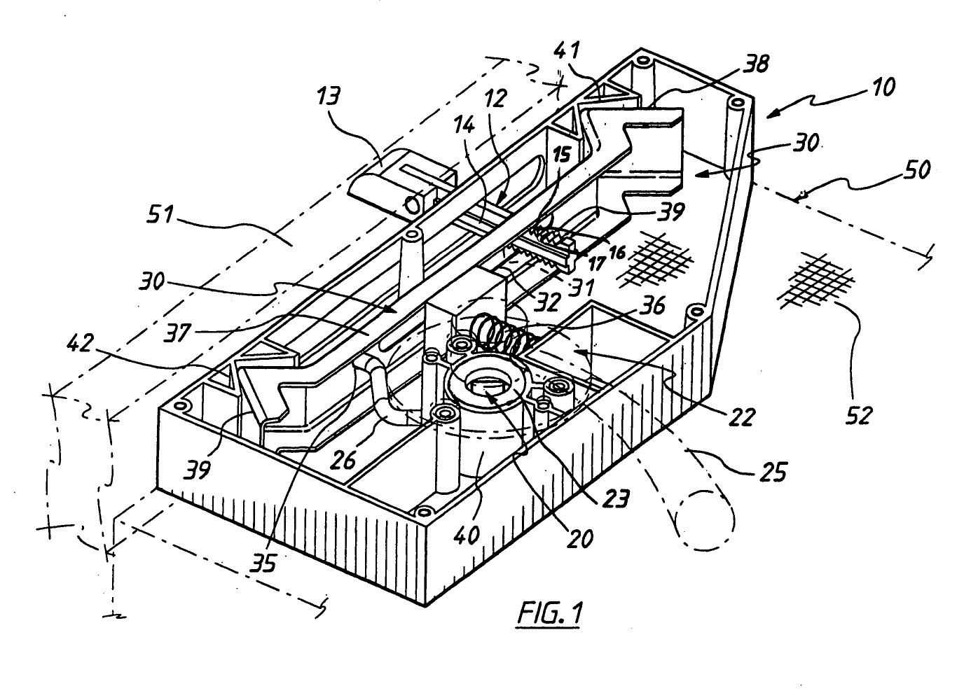

FIG. 1 is a schematic perspective view of a latch assembly according to one embodiment of the present invention;

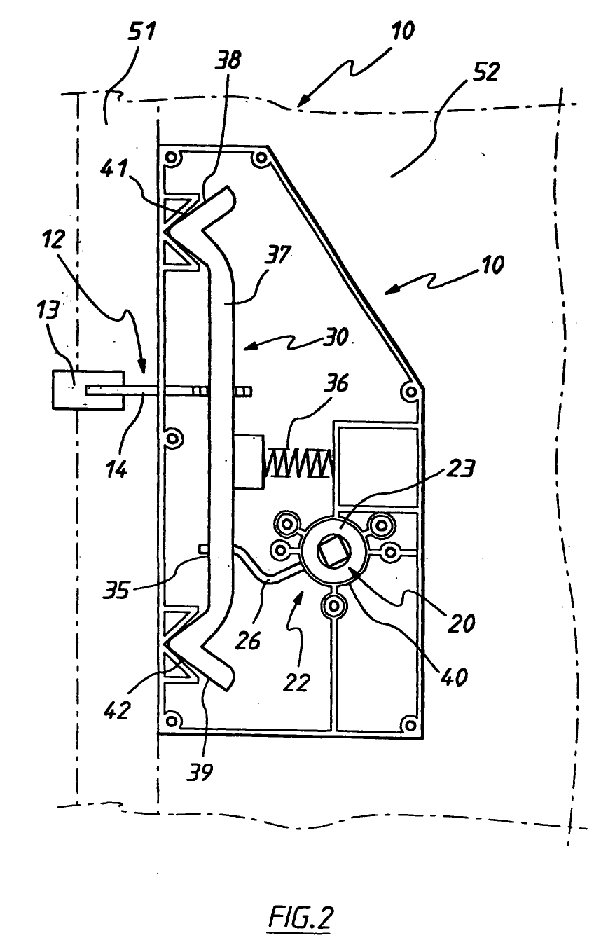

FIG. 2 is a side view to the latch assembly shown in FIG. 1 showing the latch bolt in the extended position;

FIG. 3 is a similar view to that of FIG. 3 with the latch bolt in the retracted position;

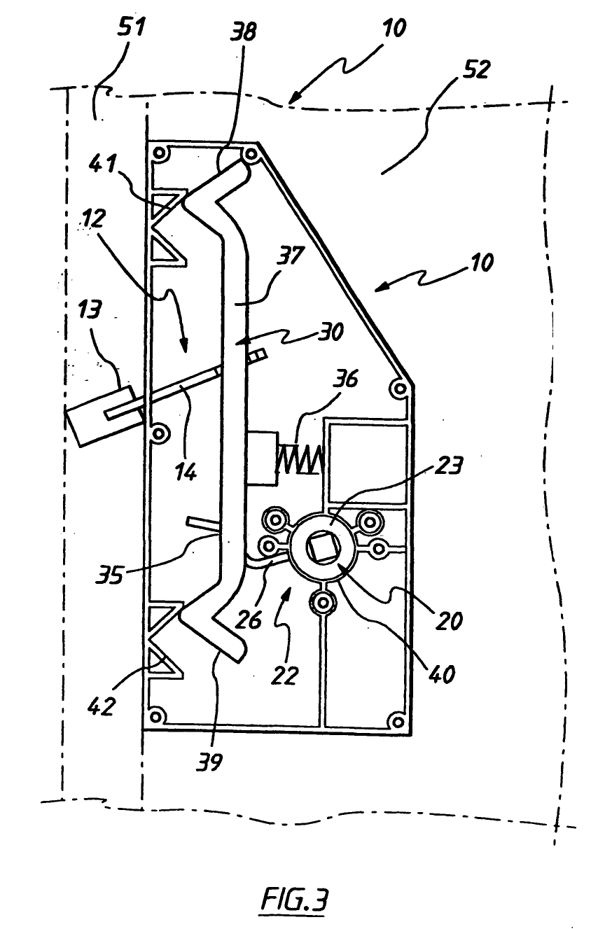

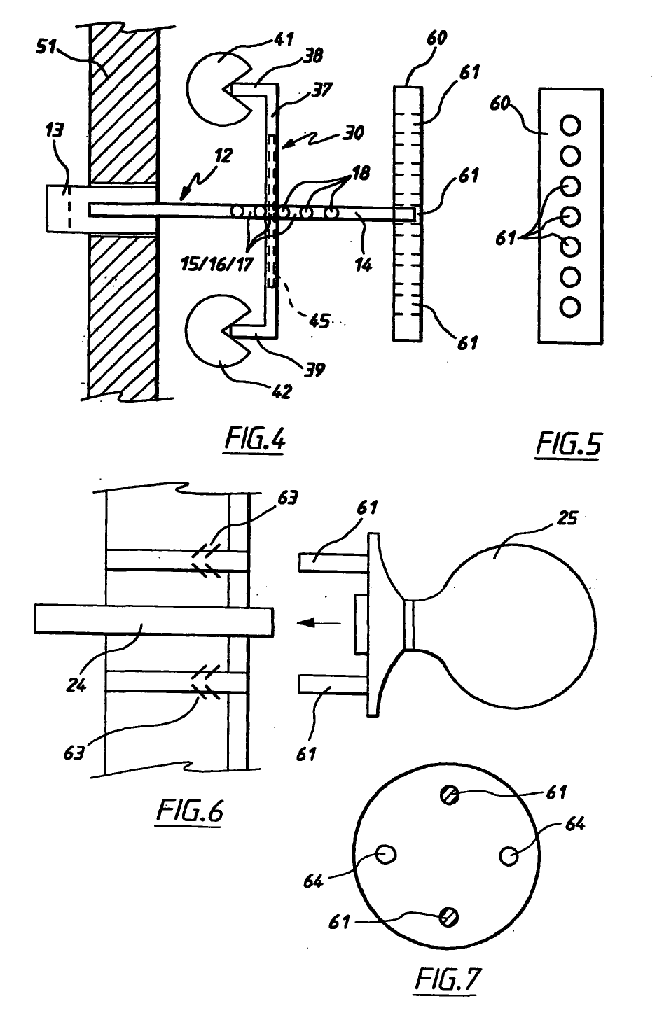

FIG. 4 is a schematic view of part of a latch assembly according to another embodiment of the present invention;

FIG. 5 is an end elevation of part of the assembly shown in FIG. 4;

FIG. 6 is a schematic side elevation showing one manner of attaching the handle to the door; and

FIG. 7 is an end view of part of the handle.

Referring to FIGS. 1 to 3 of the drawings there is shown a latch assembly generally indicated at 10 which is adapted to be mounted to a door 50. The door 50 comprises a peripheral frame 51 (only part of which is shown) to which two opposed side face panels 52 (only one of which is partially shown) are attached.

The latch assembly 10 is adapted to be mounted to the door 50, preferably for example by gluing and includes a housing for receiving a latch bolt 12 and a bolt actuating mechanism 20. In FIG. 1 the end cover of the housing has been removed. The latch bolt 12 is adapted to cooperate with a keeper formed in a door jamb when the door 50 is in a fitted position. The latch bolt 12 is adapted to be moved by the bolt actuating mechanism 20 for movement between an extended position and a retracted position. The latch bolt 12 includes a bolt head 13 which in the latching position is adapted to engage the keeper and a connecting rod 14 which is operatively connectable to the bolt actuating mechanism 20. At the end of the connecting rod 14 of the bolt 12 remote from the bolt head 13 there is provided a plurality of connecting sections, three of which are identified by reference numerals 15, 16 and 17 which are disposed side by side. The connecting sections are in the form of V-shaped notches along opposed edges of the bolt connecting rod 14. The latch bolt 12 may be formed as a one piece casting. The function of this part of the latch bolt will become apparent from the following description.

The bolt actuating mechanism 20 includes a drive assembly 22 which includes a rotatable element 23 of circular cross section mounted for rotation within a housing 40. The rotatable element 23 is adapted to receive a spindle (not shown) partially therein which in turn is operatively connected to a handle 25 (FIG. 1 in phantom). A coupling pin 26 is operatively connected to or integral with the rotatable member 23 so as to extend therefrom. Pin 26 may be connected to rotatable member 25 through a slot (not shown) in the wall of housing 40. The arrangement is such that rotation of the rotatable member 23 causes movement of the coupling pin 26.

The actuating mechanism 20 further includes a control member 30 in the form of an elongated bar 37 which is mounted for movement both in a longitudinal and lateral direction with respect to the longitudinal axis of the bar. The control bar 37 includes tracking sections 38 and 39 which cooperate with guides 41 and 42 which form part of the housing and which control the direction of movement of the control bar 37. Each of the guides is V-shaped or any other suitable shape with each leg of the V-shaped guide defining a guide surface. The edge of each tracking section 38 and 39 is disposed adjacent the junction of the guide surfaces when the bolt is in the extended or latching position. Spring 36 normally urges the tracking sections into this position. A coupling aperture 35 is formed in the control bar 37 for receiving the coupling pin 26 in sliding relation relative thereto. Thus, rotation of the rotatable member 23 causes movement of the coupling pin 26 which in turn causes movement of the control bar 37 guided by guides 41 and 42. It will be appreciated that rotation of member 23 in either direction will cause movement of the control bar due to the V-shaped guides. In another form of the invention the coupling pin 26 may be directly connected to the bar 37 so that there is no sliding movement therebetween. By this arrangement one or both of the guides may not be necessary.

The control bar 37 further includes a mounting slot 49 for receiving the connecting rod of the latch bolt 12. The mounting slot has upper and lower parallel edges 31 and 32. A selected one of the mounting sections 15, 16, or 17 for example can be operatively coupled to the control bar by locating opposed notches with the edges 31 and 32 extending into them. This can be achieved by rotating the connecting rod from a position in which the connecting rod can pass into the slot to a position in which the recesses are engaged by the edges 31 and 32.

Referring now to FIGS. 4 and 5 there is shown a second embodiment of latch assembly according to the present invention. In this embodiment, some of the parts such as for example, the drive assembly are not shown. Furthermore, like numerals have been used to identify like parts.

In this particular embodiment, the latch assembly 10 comprises a latch bolt 12 which is structurally similar to that described in the earlier embodiment although in this embodiment the connecting rod includes a plurality of locating pins 18 defining the mounting positions therebetween. The control member 30 is in the form of a bar 37 having an elongated slot 45 therein through which the connecting rod 14 passes. The latch bolt is held within the slot by the locating pins 18. In this particular arrangement, the latch bolt can move in the direction of its longitudinal axis but can also slide along the slot 45. The end of the connecting rod 14 is located in a selected one of a series of guide holes 61 in a guide bar 60 which is fixed to the door. The arrangement is such that the drive mechanism will cause movement of the control bar in a similar fashion to that described with reference to the first embodiment except in this particular case, the movement of the bolt is limited to longitudinal movement because of the relative sliding movement between the latch bolt and the control bar.

Referring now to FIGS. 6 and 7 there is shown a means by which the handle 25 of the assembly can be mounted to the door. To this end, the handle 25 may include a pair of locating pins 61 receivable within one way locating recesses 63 in the door. The locating recesses have barbs which inhibit removal of the pins once inserted into the recesses. The handle may further include mounting apertures 64 for receiving fasteners such as screws or the like.

Thus, it will be appreciated that the latch bolt can be fitted to the control bar in a selected position so that alignment of the keeper, latch bolt and drive mechanism is no longer a problem. Furthermore, the effective length of the latch bolt can be altered by selected fitting of it to the control bar. It is therefor not critical to precisely position the housing within the door. The position of the handle can be fixed but the latch bolt position remains flexible.

Finally, it is to be understood that various alterations, modifications and/or additions may be incorporated into the various constructions and arrangements of parts without departing from the spirit or ambit of the invention.

1. A latch assembly which is suitable for use with doors, windows and other movable members adapted for movement between one or more positions, the assembly including a latch bolt movable in a direction of travel between an extended position and a retracted position and a bolt actuating mechanism operable to cause the movement of the latch bolt, the bolt actuating mechanism including drive means and a control member which operatively interconnects the latch bolt and the drive means, the control member including a latch bolt mounting region which enables the latch bolt to be operatively connected to the control member in selected one of a plurality of mounting positions arranged laterally with respect to the direction of travel of the latch bolt.

2. A latch assembly according to claim 1 wherein the control member includes an elongated bar with the mounting positions disposed therealong, the mounting region being in the form of one or more slots in the elongated bar.

3. A latch assembly according to claim 1 or claim 2 wherein the latch bolt includes means for releasably connecting the bolt to a selected one of the mounting positions, said means including one or more notches which in a first position enables the bolt end to be inserted into the aperture or slot and then rotate it to a position wherein removal from the mounting position is inhibited.

4. A latch assembly according to any preceding claim 1 wherein including spring means for urging the control member and latch bolt into the extended position.

5. A latch assembly according to any preceding claim 1 wherein the drive means includes a housing for a rotatable member which is operatively connected to the latch bolt so that rotation of the rotatable member causes the control bar to move so as to cause the latch bolt to move between the extending and retracted positions, a handle operatively connected to the rotatable member, the handle being manually operable.

6. A latch assembly according to any preceding claim 1 further including guide means for assisting in guiding the movement of the control member.

7. A latch assembly according to claim 1 wherein the control member includes an elongated bar with a slot therein, the latch bolt including one or more locating pins, the latch bolt being mounted so that it can slide relative to the bar but is held captive in the direction of the longitudinal axis of the latch bolt, a latch bolt guide which limits movement of the latch bolt in the direction of its longitudinal axis, the latch bolt guide being in the form of a bar having a series of guide holes therein and arranged so that the end of the latch bolt can be received within a selected one of the guide holes so that the bolt can move relative thereto in the direction of the longitudinal axis of the bolt.
